(19) United States
(12) Patent Application Publication
(10) Pub. No.: US 2006/0144340 A1
(43) Pub. Date: Jul. 6, 2006

(54) Apparatus for a disposable pet food feeding container

(76) Inventors: Gary W. Burge, Marion, VA (US); Debra Sue Totten, Saltville, VA (US)

Correspondence Address: BAY AREA INTELLECTUAL PROPERTY GROUP, LLC, PO BOX 210459, SAN FRANCISCO, CA, 94121-0459, US

(21) Appl. No.: 11/316,163

(22) Filed: Dec. 21, 2005

Related U.S. Application Data
(60) Provisional application No. 60/641,254, filed on Jan. 3, 2005.

(51) Int. Cl. A01K 5/01

(52) U.S. Cl. 119/61.5

(57) ABSTRACT

One aspect of the present invention provides a self-contained bowl and pet food packaging technique for the purpose of providing the pet owner with a clean, convenient and efficient means of feeding the pet. One approach is described that generally comprises a disposable bowl, having specific desirable design, pet food, wet, dry, snacks, liquid, or powder or any combination thereof, and a sealing lid, which is also disposable.

### CROSS-REFERENCE TO RELATED APPLICATIONS

The present Utility patent application claims priority benefit of the U.S. provisional application for patent No. 60/641,254 filed on Jan. 3, 2005 under 35 U.S.C. 119(e). The contents of this related provisional application are incorporated herein by reference.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patents file or records, but otherwise reserves all copyright rights whatsoever.

### FIELD OF THE INVENTION

The present invention relates generally to pet food packaging and more specifically to a pet food bowl that contains pet food and is disposable for convenience.

### BACKGROUND OF THE INVENTION

It can be appreciated that disposable food containers for human use have been utilized for years such as in TV dinner containers. However, no known solutions exist to this problem for the pet food industry. Most conventional approaches package pet food in a standard can, box, bag, or a convenience pouch.

A significant inconvenience associated with conventional pet food containers is that once they are opened, the food must be physically removed from the container, often utilizing a utensil, and then placed into a bowl, usually constructed of plastic or metal, from which the pet feeds. The bowl and utensil must thereafter be washed and the packaging materials disposed of. Similarly, conventional canned pet food packaging often further requires that the user open the package sometimes utilizing a can opener, whereby the can opener must then be washed of the pet food before human use.

Another inconvenience is that the pet food must be extracted from the conventional pet food packaging, often by way of a utensil, usually a common fork or spoon destined for human use that also must be cleansed after extraction of the pet food product.

In addition, another inconvenience associated with common pet food bowls is that they are designed to be permanent eating containers, and therefore must also be washed and cleansed, generally in the kitchen sink, at appropriate intervals, which tends to create a highly unsanitary condition.

Typically, dry pet food is not currently provided in individual, pre-measured quantities and also is not provided with its own feeding container, thereby requiring the pet owner to have an opened bag or box of dry pet food that is subject to spillage. Moreover, separately, a feeding bowl must be provided that also must be cleansed at appropriate intervals.

A problem with conventional pet food packaging is that it is not capable of conveniently providing a variety of food types in one package, and also is not provided with its own feeding container.

Regarding pouch type pet food packaging containers, it is well known that the food contained therein is extremely difficult to remove from the pouch.

Conventional pet food packaging is also not convenient for the purpose of providing pet food while traveling with a pet. Traveling with a pet requires the pet owner to have pet food, utensils, openers, and bowls, all of which are inconvenient, cumbersome and generally unsanitary.

Conventional pet food packaging also generally lacks the capability of conveniently providing powdered milk products. Similarly, known powdered milk or powdered milk substitute type products are not provided in conjunction with wet or dry pet food product.

Some known pet food packaging approaches geared towards convenience packaging is that while the pet food is provided in a disposable container, the container is generally not suitable as an eating container or bowl. Often, they are designed too small for the pet to feed from, possess sharp vertical sides which tend to make it impossible for the pet to extract most of the contents, or they possess a high center of gravity which tends to make it impossible for the pet to extract the contents without tipping the feeding container over. Such conventional techniques also typically suffer from slippage when the feeding container is placed on a smooth flooring such as common linoleum or tile floor where it tends to slide as the pet attempts to extract the contents.

In view of the foregoing, there is a need for improved techniques for pet food packaging such that the user is provided with a disposable pet food container that is convenient to open and also serves as a pet feeding bowl already containing the pet's food, thereby enabling the pet owner to simply dispose of the used feeding bowl after the pet is done feeding.

### BRIEF DESCRIPTION OF THE DRAWINGS

The present invention is illustrated by way of example, and not by way of limitations in the figures of the accompanying, drawings and in which like reference numerals refer to similar elements and in which:

FIG. 1 illustrates a top perspective view of an exemplary singular chambered embodiment of the present invention having a disposable bowl and accompanying lid;

FIG. 2 illustrates the side view of the singular chambered embodiment of FIG. 1:

FIG. 3 illustrates a top perspective view of an exemplary dual chambered disposable bowl embodiment of the present invention:

FIG. 4 illustrates a top perspective view of an exemplary disposable bowl having a multiplicity of feeding bowl chambers in accordance with an embodiment of the present invention;

FIG. 5 illustrates a bottom perspective view of an exemplary singular chambered disposable bowl further provided with a stabilizing skirt, in accordance with an embodiment of the present invention;

FIG. 6 illustrates a bottom perspective view of an exemplary dual chambered disposable bowl further provided with a structurally stabilizing lip, in accordance with an embodiment of the present invention;

FIG. 7 illustrates a bottom perspective view of the singular chambered embodiment disposable bowl further provided with an exemplary non-slip surface attachment, in accordance with an embodiment of the present invention; and

FIG. 8 illustrates a bottom perspective view of the singular chambered disposable bowl embodiment further provided with a preferred non-slip surface attachment, in accordance with an embodiment of the present invention.

Unless otherwise indicated illustrations in the figures are not necessarily drawn to scale.

### SUMMARY OF THE INVENTION

To achieve the foregoing and other objects and in accordance with the purpose of the invention, a variety of techniques for a disposable pet food feeding container are described.

One aspect of the present invention provides a new self-contained bowl and food pet food packaging technique wherein the same can be utilized for the purpose of providing the pet owner with a clean, convenient, and efficient means of feeding the pet. One embodiment of the present invention generally comprises a disposable bowl, having specific desirable design, pet food, wet, dry, snacks, liquid, or powder or any combination thereof, and a sealing lid, which is also disposable.

Another embodiment of the present invention also comprises a disposable bowl containing, pet food that possesses either a singular bowl chamber or a plurality of interconnected, separate bowl chambers.

Another aspect of the present invention is to provide a disposable pet food bowl containing food that will overcome the shortcomings of the prior art.

Yet another aspect of the present invention is to provide a disposable pet food bowl containing food that will be easily opened by means of a pull-top type lid.

Yet another aspect of the present invention is to provide the pet food, which can be provided in any and all forms, wet, dry, snacks, liquid, or powder, or any combination thereof, prepackaged in the disposable pet food bowl.

Yet another aspect of the present invention is to provide a bowl, which can be disposed of after use.

Yet another aspect of the present invention is that the bowl may optionally be provided with a non-slip lower surface to avoid sliding across the floor while the pet consumes the contents.

Yet another aspect of the present invention is to provide a disposable bowl which should be designed with a low center of gravity to avoid tipping.

Yet another aspect of the present invention is to optionally incorporate into the bowl design, large radii on some or all lower edges and corners with which to enable the pet to easily extract the food contents.

Yet another aspect of the present invention is to provide an embodiment of the present invention that may possess a singular bowl chamber which may be embodied in various sizes and geometric configurations for the purpose of accommodating any sized pet, or quantity and type of pet food.

Yet another aspect of the present invention is to provide an embodiment of the present invention which may possess a plurality of interconnected, separate bowl chambers which may be embodied in various sizes, combinations of sizes, and geometric configurations for the purpose of accommodating any sized pet, or quantity and type of pet food.

Yet another aspect of the present invention is to provide an embodiment of the present invention that may possess a plurality of interconnected, separate, disposable bowl chambers, containing pet food, which can serve as both feeding and drinking bowls, specifically designed for providing food and liquid when traveling with a pet.

Yet another aspect of the present invention is to provide an embodiment of the present invention which may possess a plurality of interconnected, separate, disposable bowl chambers, of which one bowl chamber may serve as a drinking bowl, and may be provided void and empty of wet, dry, snacks, liquid, or powdered pet food products, for the purpose of the user's addition of liquid when traveling with a pet.

Yet another aspect of the present invention is to provide an embodiment of the present invention which may possess a plurality of interconnected, separate, disposable bowl chambers containing pet food for the purpose of providing the pet with a variety of pet food types.

Yet another aspect of the present invention is to provide a disposable bowl containing pet food that may, in the singular embodiment, or in the embodiment of a plurality of interconnected, separate, disposable bowl chambers contain a powdered milk or powdered milk substitute type product.

Yet another aspect of the present invention is to provide a disposable bowl containing pet food which may incorporate in the embodiment, a skirt, extending from the upper perimeter edge of the bowl to a point approximately even with the lower contact surface for the purpose of stabilizing the bowl.

Yet another aspect of the present invention is to provide a disposable bowl containing pet food which mats incorporate in the embodiment, a lip, extending from the upper perimeter surface downwards to any distance for the purpose of adding structural integrity to the multi-chambered embodiment of the invention.

Yet another aspect of the present invention is to provide a disposable bowl containing pet food, of which, the embodiment may be produced in any color.

Other features, advantages, and object of the present invention will become more apparent and be mole readily understood from the following detailed descriptions which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments.

Turning now descriptively to the drawings the attached figures illustrate various exemplary implementations of a disposable bowl containing pet food in accordance with embodiments of the present invention which generally comprise a disposable bowl having a suitable design, pet food, and a sealing lid (e.g., of the pull top type). For the sake of clarity, the contained pet food is not illustrated, as it would obscure the view of the bowl design. It should be further appreciated that the type, quantity, or volume of pet food contained therein, may be adjusted per individual desires, marketing schemes, or other requirements.

The disposable bowl embodiments described below may be manufactured by any suitable conventional technique, including, but not limited to, being formed, molded, or pressed using any) variety of commonly used packaging materials. For example, the embodiments shown may be formed utilizing any of the common thermoplastic forming methods and techniques. One such suitable method is the vacuum forming technique. By way of further example, described embodiment may also be molded into the proper shape by any of the common injection molding techniques or pressed into the propel shape by way of thermoplastic, fiber, or composite construction and produced utilizing any of the common press forming methods. Preferred embodiments of the present invention are preferably constructed of thin polystyrene, polyethylene, or PET thermoplastic; however, those skilled in the art will appreciate that any common packaging materials, thermoplastic, fiber, or composite may be used. Moreover, the particular exterior color may be applied as desired or achieved by proper selection of the structural material forming the particular embodiment of the present invention.

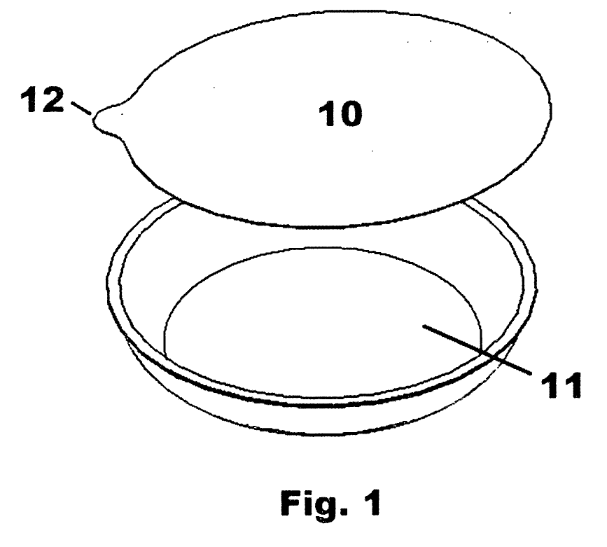

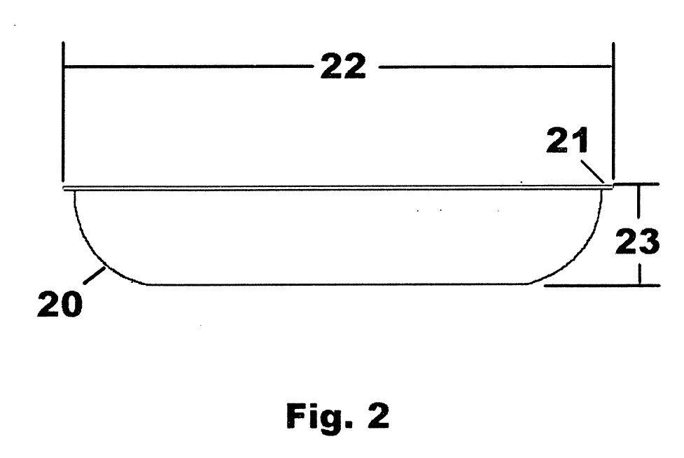

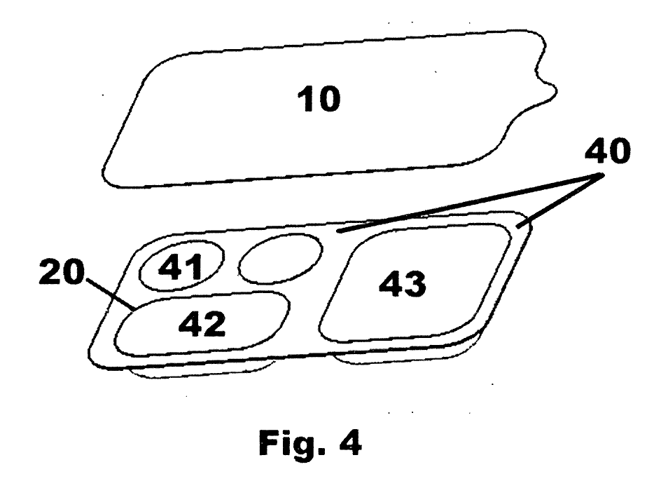

FIG. 1 illustrates a top perspective view of an exemplar singular chambered embodiment of the present invention having a disposable bowl and accompanying lid. In the Figure, a single chambered disposable bowl embodiment (11) is shown. FIG. 2 illustrates the side view of the singular chambered embodiment of FIG. 1, which shows a relatively large corner radius (20) on the lower edge of the container. Referring to both FIGS. 1 and 2, this radius is preferably incorporated for the purpose of enabling the pet to extract the pet food contents of the disposable bowl without encountering the encumbrance of a sharp vertical wall and corner, which tend to impede access by the pet to the pet food contained therein. Corner radius (20) is preferably configured to have a suitable curvature that enables the intended pet type to readily access and extract food resting on the inner surface of corner radius (20). This radius preferably exists in any and all embodiments and should be used at the juncture of the lower horizontal surface of the embodiment and the vertical wall of the embodiment. The radius (20) should also be applied at the conjunction of intersecting vertical walls in any non-round embodiment of the invention as illustrated by way of further example in FIG. 4 (20). Referring again to FIGS. 1 and 2, a sufficiently low center of gravity is preferably incorporated into the specific design of the disposable bowl to avoid tipping and spillage in common feeding situations. This may be accomplished by appropriately configuring the design of the disposable bowl for the specific container volume and type of pet food contained therein. Often, these requirements are dictated by sales and marketing considerations. An outer and/or maximum perimeter diameter (22) of the upper surface of the disposable bowl preferably should be as large as practical, thereby requiring a minimum of overall height (23) of the disposable bowl. A rim (21) of disposable bowl (11) is preferably configured for the purpose of attaching or sealing a pull-top type lid (10) to the container. For embodiments having an alterative lid approach rim (21) may not be necessary and/or may be suitably configured to mate with the particular kind of lid selected.

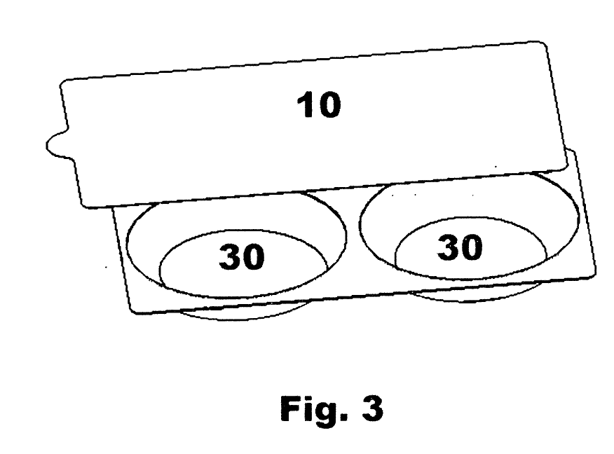

FIG. 3 illustrates a top perspective view of an exemplar-y dual chambered disposable bowl embodiment (30) of the present invention. The embodiment shown permits a wide variety and combination of pet food products to be incorporated. The bowl chambers may be formed in any desirable geometric shape or configuration.

FIG. 4 illustrates a top perspective view of an exemplary disposable bowl (40) having a multiplicity of feeding bowl chambers in accordance with an embodiment of the present invention. Various shapes of bowl chambers are shown for the purpose of providing a container, which may be filled with wide and diverse types of pet food products for the pet. Those skilled in the art will readily recognize a multiplicity of alternate and suitable bowl chamber configurations depending on the needs of the particular application. As shown by way of example, a square chamber (43), a rectangular chamber, (42), and a smaller, circular chamber configuration (41) are illustrated. These varied shapes may be incorporated into the design of singular dual, or multiple chambered embodiments of disposable bowls in accordance with the teachings of the present invention.

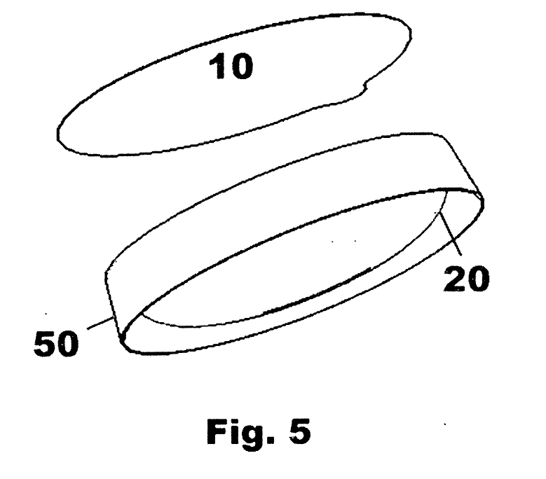

FIG. 5 illustrates a bottom perspective view of an exemplary singular chambered disposable bowl further provided with a stabilizing skirt (50), in accordance with an embodiment of the present invention. This stabilizing skirt (50) may be incorporated into the general design of any embodiment of the present invention. In many applications, the stabilizing skirt (50) stabilizes the feeding bowl to avoid tipping and spillage, thereby lessening the volume to size ratio design restrictions and achieving the lowest center of gravity possible. Essentially, incorporation of a stabilizing skirt allows volume to size marketing requirements to be met without sacrificing desirable anti-tipping and spillage characteristics. The stabilizing skirt preferably should extend from the upper horizontal plane of the bowl structure, vertically, or angularly, to the lower plane of the bowl structure and be an integral part of the overall structure. In some applications, the stabilizing skirt (50) may be included for mainly aesthetic reasons.

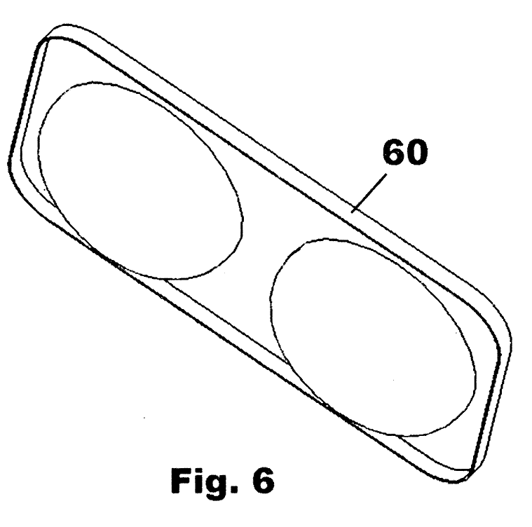

FIG. 6 illustrates a bottom perspective view of an exemplary dual chambered disposable bowl further provided with a structurally stabilizing lip (60), in accordance with an embodiment of the present invention. This structurally stabilizing lip (60), may be incorporated into the design of any embodiment of the present invention. In many applications the stabilizing lip (60) structurally strengthens a multiple chambered embodiment of the present invention horizontally against bending moment stresses and as such may be deemed a desirable quality in the handling, packing and shipment of the disposable bowl containing pet food. The stabilizing lip (60) preferably should extend from the upper horizontal plane of the disposable bowl, to any suitable dimension toward the lower horizontal plane of the disposable bowl so that it provides the desired stabilization or the reinforcement strength to the material (e.g. thermoplastic, fiber, or composite) chosen for the fabrication of the bowl.

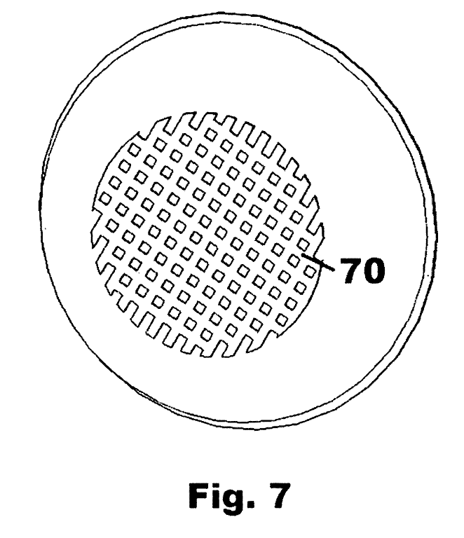

FIG. 7 illustrates a bottom perspective view of the singular chambered embodiment disposable bowl further provided with an exemplary non-slip surface attachment (70), in accordance with an embodiment of the present invention. Non-slip surface attachment (70) attachment is primarily provided to resist the sliding of the disposable bowl containing pet food over a smooth surface which it may be placed upon while the pet is feeding there from. This non-skid attachment (70) may optionally be incorporated into any embodiment of the present invention. This attachment may be comprised of any suitable material, including but not limited to, thin rubber, capable of preventing or resisting sliding on smooth surfaces. In some alternative embodiments the non-skid attachment may be formed as a raised texture from the material making the disposable bowl itself when such material's surface provides adequate anti-skip properties for the particular application

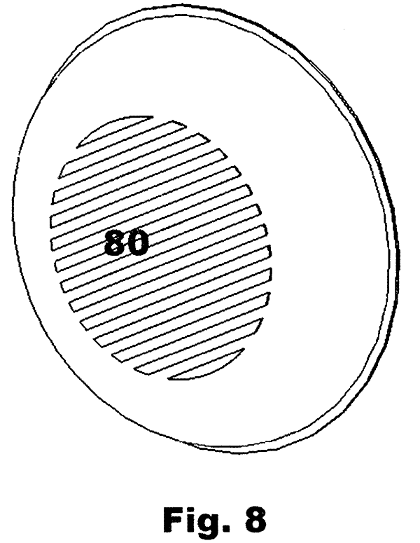

FIG. 8 illustrates a bottom perspective view of the singular chambered disposable bowl embodiment further provided with a preferred non-slip surface attachment (80), in accordance with an embodiment of the present invention. The preferred approach to providing non-slip surface attachment (80) by the application of a hot melt adhesive possessing residual tack, or stickiness, properties when cooled or a bead of urethane foam, which likewise possesses residual tack properties. Those skilled in the art will recognize a multiplicity of alternative and suitable techniques that result in a surface possess some degree of residual tack to resist the sliding of the disposable feeding bowl. Moreover, although a grid pattern is shown, any desired pattern, including shape specific patterns, may be implemented depending upon the needs of the particular application. The exact size and/or spacing of the application of the non-slip material depends upon the details of the particular application, and is typically based upon the specific tackiness and variety of material chosen to be applied. The present non-slip surface may also be comprised of any material capable of adhesion to the bottom of the present disposable feeding bowl and, in addition, possessing, to an adequate degree, non-slip properties or tackiness. Methods to accomplish such non-Slip surfaces are well known to those skilled in the art.

It should be appreciated that embodiments of the disposable pet food feeding container made and used in accordance with the teachings of the present invention may be suitably configured by those skilled in the art to appropriately contain any kind of pet food that is currently produced commercially, including, but not limited to, “wet” food. “dry” food, “snacks”, liquid, or powdered, or any combination thereof. Moreover, the pet food contained therein may also be powdered milk or powdered milk substitute or a protein equivalent. Typically, in prepackaged embodiments, the volume, quantity, and variety of the pet food contained within specific bowl chambers of embodiment's of the present invention, will be determined by the manufacturer and target market being served. In some applications, one or more of the bowl chambers of embodiments of the present invention may be left void and empty of any pet food products; for example, to provide a built-in bowl chamber for the user to add water or other fluids, or to split/mix food portions. Those skilled in the art will readily recognize how to configure embodiments of the disposable pet food feeding container embodiments of the present invention to incorporate well known techniques for sterilization and preservation of contained pet food depending on the requirements of the particular application; e.g., in some applications important factors include food type and shelf life time constraints.

The sealing pull top type lid (10) may be fabricated by any suitable methods currently well known to those in the art. By way of example, and not limitation, it may be comprised of thermoplastic, foil or metal, fiber, or any other commonly utilized packaging materials for the particular application. In preferred embodiments of the present inventions pull top type lid (10) preferably possess either a tab (12), incorporated into the design of the lid, or any other suitable kind of “easy open” type attachment such as, for example, a metal pull tab or any other of the commonly used methods providing for convenient removal of the lid from the disposable bowl embodiment as will be readily apparent to those skilled in the art. Depending on the particular application, a sealing pull top type lid (10) may be attached to rim (21) of the disposable pet food feeding bowl after introducing pet food into the bowl chamber by way of a multiplicity of well known and suitable methods, including but not limited to, applying adhesive, crimping, heat sealing, etc. After the bowl chamber(s) are properly filled with the appropriate type and quantity of pet food as required by the particular application, pull top type lid (10) is properly sealed thereon and this completed disposable pet food feeding container is ready for use.

In some, alternate resealable embodiments of the present invention, the end user (e.g., the pet owner), instead, is provided with an empty, unsealed, version of the foregoing embodiments, which is appropriately modified according to known principles to permit the end user to reseal the lid such that the sealed pet food feeding container may be stored or transported without spillage of its contents.

Having fully described at least one embodiment of the present invention, other equivalent or alternative methods of implementing disposable pet food feeding containers according to the present invention will be apparent to those skilled in the art. The invention has been described above by way of illustration, and the specific embodiments disclosed are not intended to limit the invention to the particular forms disclosed. The invention is thus to cover all modifications, equivalents, and alternatives falling within the spirit and scope of the following claims.

What is claimed is:

1. An apparatus for disposablely containing pet food for feeding to pets, the apparatus comprising:
a disposable container configured with at least one bowl chamber, said at least one bowl chamber being operable for properly containing pet food;
pet food, the pet food being contained within said bowl chamber; and
a sealing lid, said lid being configured to sealingly join with and cover said disposable container and said at least one bowl chamber, thereby containing the pet food within said disposable container and lid combination.

2. The disposable pet food containing apparatus of claim 1, in which the seal of said lid is configured to be operable to seal against the leaking of contained pet food that is wet, dry, snacks, liquid, and/or powdered.

3. The disposable pet food containing apparatus of claim 3, in which at least some of the pet food is wet, dry, snacks, liquid, powdered, powdered milk, and/or a milk substitute type product.

4. The disposable pet food containing, apparatus of claim 1, in which said disposable container is further configured to have a low enough center-of-gravity such that when containing pet food said low center of gravity disposable container resists toppling over and spilling the pet food contents during normal use by a feeding pet.

5. The disposable pet food containing apparatus of claim 1, in which said disposable container is further configured with a mechanically stabilizing lip or skirt disposed about an outer edge such that when containing pet food said lipped or skirted disposable container resists toppling over and spilling the pet food contents during normal use by a feeding pet.

6. The disposable pet food containing apparatus of claim 1, in which said disposable container and/or said at least one bowl chamber is configured into a geometric shape.

7. The disposable pet food containing apparatus of claim 6, in which the geometric shape is round, oval, square, or rectangular.

8. The disposable pet food containing apparatus of claim 1, in which said at least one bowl chamber comprises a curved lower edge or corner, said curved lower edge or corner being configured to be curved with a large enough radii of curvature to facilitate a pet to easily extract the pet food contents from said at least one bowl chamber.

9. The disposable pet food containing apparatus of claim 1, further comprising means for improving the convenience of feeding a pet while traveling.

10. The disposable pet food containing apparatus of claim 1, in which there is only one bowl chamber.

11. The disposable pet food containing apparatus of claim 1, in which there is a plurality of bowl chambers, configured according to at least one different size.

12. The disposable pet food containing apparatus of claim 1I in which said disposable container and/or said at least one bowl chamber comprises an exposed bottom surface that rests on the floor during normal use, and said bottom exposed bottom surface is configured with a non slip surface thereupon.

13. The disposable pet food containing apparatus of claim 1, in which said sealing lid is configured to be an “easy open” pull top type lid.

14. The disposable pet food containing apparatus of claim 1, in which said sealing lid is configured to be a re-sealable lid.

15. An apparatus for disposablely containing pet food for feeding to pets, the apparatus comprising:
means for properly containing pet food;
pet food, the pet food being contained within said containing means; and
means for covering said containing means, thereby containing the pet food within said containing means and covering means combination.

16. The disposable pet food containing apparatus of claim 15, in which said containing means comprises means for resisting the toppling over and spilling of the pet food contents during normal use by a feeding pet.

17. The disposable pet food containing apparatus of claim 15, in which said containing means is further configured with means for resisting the toppling over and spilling of the pet food contents during normal use by a feeding pet.

18. The disposable pet food containing apparatus of claim 15, in which said containing comprises means for facilitating a pet to extract the pet food contents said containing means.

19. The disposable pet food containing apparatus of claim 15, in which said containing comprises means comprises an exposed bottom surface that rests on the floor, and said bottom exposed bottom surface being configured means for resisting slippage on the floor during normal use.

20. An apparatus for disposablely containing pet food for feeding to pets, the apparatus comprising:
a disposable container configured with at least one bowl chamber, said at least one bowl chamber being operable for properly containing pet food, said at least one bowl chamber comprising a curved lower edge or corner said curved lower edge or corner being configured to be curved with a large enough radii of curvature to facilitate a pet to easily extract the pet food contents from said at least one bowl chamber, and said disposable container and/or said at least one bowl chamber further comprising an exposed bottom surface that rests on the floor during normal use, and said bottom exposed bottom surface being configured with a non-slip surface thereupon;
pet food, the pet food being contained within said bowl chamber, said disposable container being further configured to have a low enough center-of-gravity such that when containing pet food said low center of gravity disposable container resists toppling over and spilling the pet food contents during normal use by a feeding pet, said disposable container being also configured with a mechanically stabilizing lip or skirt disposed about an outer edge such that when containing pet food said lipped or skirted disposable container resists toppling over and spilling the pet food contents during normal use by a feeding pet;
a sealing lid, said lid being configured to sealingly join with and cover said disposable container and said at least one bowl chamber, thereby containing the pet food within said disposable container and lid combination.
